(19) United States
(12) Patent Application Publication
(10) Pub. No.: US 2025/0355582 A1
(43) Pub. Date: Nov. 20, 2025

(54) MEMORY SYSTEM INITIALIZATION TRIGGER

(71) Applicant: Micron Technology, Inc., Boise, ID (US)

(72) Inventors: Liang Yu, Boise, ID (US); Jonathan S. Parry, Boise, ID (US); Vipul Patel, Santa Clara, CA (US); Deping He, Boise, ID (US)

(21) Appl. No.: 19/185,033

(22) Filed: Apr. 21, 2025

Related U.S. Application Data
(60) Provisional application No. 63/649,897, filed on May 20, 2024.

(51) Int. Cl. G06F 3/06

(52) U.S. Cl. CPC G06F 3/0632; G06F 3/0622; G06F 3/0688

(57) ABSTRACT

Methods, systems, and devices for triggering initialization at a memory system are described. The memory system may receive, from a host device, a first command that indicates the memory system to exit a sleep state, and the memory system initiate, in response to the first command, a wakeup procedure for a controller of the memory system, the wakeup procedure including a configuration of an interface between the controller and one or more memory devices. The memory system may issue, prior to completion of the configuration of the interface and in response to the first command, a first signal via a signal pin of the controller to the one or more memory devices to trigger an initialization procedure at the one or more memory devices, and the memory system may perform one or more access operations at the one or more memory devices based on triggering the initialization procedure.

### CROSS REFERENCE

The present application for patent claims priority to U.S. Patent Application No. 63/649,897 by Yu et al., entitled “MEMORY SYSTEM INITIALIZATION TRIGGER,” filed May 20, 2024, which is assigned to the assignee hereof, and which is expressly incorporated by reference in its entirety herein.

### TECHNICAL FIELD

The following relates to one or more systems or techniques for memory, including memory system initialization trigger.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports triggers for initialization procedures in accordance with examples as disclosed herein.

FIG. 2 shows an example of a timing diagram that supports triggers for initialization procedures in accordance with examples as disclosed herein.

FIG. 3 shows an example of a diagram that supports triggers for initialization procedures in accordance with examples as disclosed herein.

FIG. 4A and FIG. 4B show examples of diagrams that support triggers for initialization procedures in accordance with examples as disclosed herein.

FIG. 5 shows a block diagram of a memory system that supports triggers for initialization procedures in accordance with examples as disclosed herein.

FIG. 6 shows a flowchart illustrating a method or methods that support triggering of NAND initialization in accordance with examples as disclosed herein.

### DETAILED DESCRIPTION

In some cases, memory systems, such as managed NAND (mNAND) systems, may be associated with a relatively large latency for exiting a sleep state. For example, when a host device issues a command that causes an mNAND system to exit a sleep state, the mNAND system may first perform a wakeup procedure for hardware components of an integrated controller (e.g., an application specific integrated controller (ASIC)). The wakeup procedure may include an initialization for one or more interfaces, such as an open NAND flash interface (ONFI). An interface such as the ONFI may then trigger an initialization for one or more NAND devices of the mNAND system. As such, the initialization for the NAND devices does not begin until after the wakeup procedure for the ONFI has taken place, causing longer delays for read response and query response by the mNAND system. Additionally, or alternatively, there may be a mismatch of ONFI configurations between the mNAND system and other systems (e.g., universal flash storage (UFS) systems) interfacing with the ONFI (e.g., due to a restart resetting the ONFI configuration back to default for another system), which may further cause issues between the mNAND system and the other systems. Accordingly, techniques for triggering the NAND initialization without relying on the ONFI initialization may be desired.

In accordance with examples as described herein, a memory system (e.g., an mNAND system) may perform an initialization procedure for one or more memory devices in parallel with hardware wakeup procedures (e.g., for a controller). To perform the initialization procedure in parallel (e.g., at least partially in parallel) with the hardware wakeup procedures, the initialization procedure may be triggered by issuing a signal via a signal pin (e.g., an input/output (I/O) pad, a general purpose input output (GPIO) pad) of a controller of the memory system to the one or more memory devices. In some examples, the memory system may include an additional signal pin dedicated to triggering the initialization procedure for the one or more memory devices. Additionally, or alternatively, the memory system may repurpose one or more existing signal pins to trigger the initialization procedure. In some cases, after triggering the initialization procedure, the signal pin may be used to trigger a reset and a subsequent initialization procedure. Accordingly, the initialization procedure for the one or more memory devices may be performed in at least partially in parallel with hardware wakeup procedures, thereby reducing the wakeup latency for the memory system.

In addition to applicability in memory systems as described herein, techniques for triggering an initialization procedure may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing wakeup latency and improving read response and query response for a memory system, which may reduce response times, or otherwise improve the user experience, among other benefits.

Features of the disclosure are illustrated and described in the context of systems, devices, and circuits. Features of the disclosure are further illustrated and described in the context of diagrams, including timing diagrams, and flowcharts.

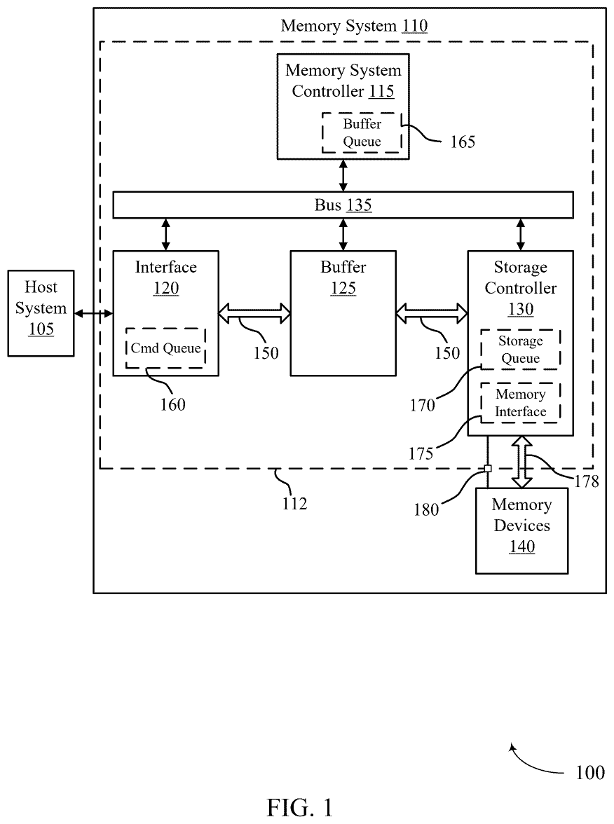

FIG. 1 shows an example of a system 100 that supports triggers for initialization procedures in accordance with examples as disclosed herein. The system 100 may include a memory system 110 configured to store data received from the host system 105 and to send data to the host system 105, if requested by the host system 105 using access commands (e.g., read commands or write commands).

The memory system 110 may include one or more memory devices 140 to store data transferred between the memory system 110 and the host system 105 (e.g., in response to receiving access commands from the host system 105). For example, the memory devices 140 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 110 may include a storage controller 130 for controlling the passing of data directly to and from the memory devices 140 (e.g., for storing data, for retrieving data, for determining memory locations in which to store data and from which to retrieve data). The storage controller 130 may communicate with memory devices 140 using memory interface 175, which may communicate with memory devices over a memory bus 178 (e.g., ONFI bus) include using a protocol specific to each type of memory device 140. In some cases, a single storage controller 130 may be used to control multiple memory devices 140 of the same or different types. In some cases, the memory system 110 may include multiple storage controllers 130 (e.g., a different storage controller 130 for each type of memory device 140).

The memory system 110 may include an interface 120 for communication with the host system 105, and a buffer 125 for temporary storage of data being transferred between the host system 105 and the memory devices 140. The interface 120, buffer 125, and storage controller 130 may support translating data between the host system 105 and the memory devices 140 (e.g., as shown by a data path 150), and may be collectively referred to as data path components.

Using the buffer 125 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 125 may include relatively fast memory (e.g., some types of volatile memory, such as SRAM or DRAM), or hardware accelerators, or both to allow fast storage and retrieval of data to and from the buffer 125. The buffer 125 may include data path switching components for bi-directional data transfer between the buffer 125 and other components.

A temporary storage of data within a buffer 125 may refer to the storage of data in the buffer 125 during the execution of access commands. For example, after completion of an access command, the associated data may no longer be maintained in the buffer 125 (e.g., may be overwritten with data for additional access commands). In some examples, the buffer 125 may be a non-cache buffer. For example, data may not be read directly from the buffer 125 by the host system 105. In some examples, read commands may be added to a queue without an operation to match the address to addresses already in the buffer 125 (e.g., without a cache address match or lookup operation).

The memory system 110 also may include a memory system controller 115 for executing the commands received from the host system 105, which may include controlling the data path components for the moving of the data. A bus 135 may be used to communicate between the system components.

In some cases, one or more queues (e.g., a command queue 160, a buffer queue 165, a storage queue 170) may be used to control the processing of access commands and the movement of corresponding data. This may be beneficial, for example, if more than one access command from the host system 105 is processed concurrently by the memory system 110. The command queue 160, buffer queue 165, and storage queue 170 are depicted at the interface 120, memory system controller 115, and storage controller 130, respectively, as examples of a possible implementation. However, queues, if implemented, may be positioned anywhere within the memory system 110.

Data transferred between the host system 105 and the memory devices 140 may be conveyed along a different path in the memory system 110 than non-data information (e.g., commands, status information). For example, the system components in the memory system 110 may communicate with each other using a bus 135, while the data may use the data path 150 through the data path components instead of the bus 135. The memory system controller 115 may control how and if data is transferred between the host system 105 and the memory devices 140 by communicating with the data path components over the bus 135 (e.g., using a protocol specific to the memory system 110).

If a host system 105 transmits access commands to the memory system 110, the commands may be received by the interface 120 (e.g., according to a protocol, such as a UFS protocol or an eMMC protocol). Thus, the interface 120 may be considered a front end of the memory system 110. After receipt of each access command, the interface 120 may communicate the command to the memory system controller 115 (e.g., via the bus 135). In some cases, each command may be added to a command queue 160 by the interface 120 to communicate the command to the memory system controller 115.

The memory system controller 115 may determine that an access command has been received based on the communication from the interface 120. In some cases, the memory system controller 115 may determine the access command has been received by retrieving the command from the command queue 160. The command may be removed from the command queue 160 after it has been retrieved (e.g., by the memory system controller 115). In some cases, the memory system controller 115 may cause the interface 120 (e.g., via the bus 135) to remove the command from the command queue 160.

After a determination that an access command has been received, the memory system controller 115 may execute the access command. For a read command, this may include obtaining data from one or more memory devices 140 and transmitting the data to the host system 105. For a write command, this may include receiving data from the host system 105 and moving the data to one or more memory devices 140. In either case, the memory system controller 115 may use the buffer 125 for, among other things, temporary storage of the data being received from or sent to the host system 105. The buffer 125 may be considered a middle end of the memory system 110. In some cases, buffer address management (e.g., pointers to address locations in the buffer 125) may be performed by hardware (e.g., dedicated circuits) in the interface 120, buffer 125, or storage controller 130.

To process a write command received from the host system 105, the memory system controller 115 may determine if the buffer 125 has sufficient available space to store the data associated with the command. For example, the memory system controller 115 may determine (e.g., via firmware, via controller firmware), an amount of space within the buffer 125 that may be available to store data associated with the write command.

In some cases, a buffer queue 165 may be used to control a flow of commands associated with data stored in the buffer 125, including write commands. The buffer queue 165 may include the access commands associated with data currently stored in the buffer 125. In some cases, the commands in the command queue 160 may be moved to the buffer queue 165 by the memory system controller 115 and may remain in the buffer queue 165 while the associated data is stored in the buffer 125. In some cases, each command in the buffer queue 165 may be associated with an address at the buffer 125. For example, pointers may be maintained that indicate where in the buffer 125 the data associated with each command is stored. Using the buffer queue 165, multiple access commands may be received sequentially from the host system 105 and at least portions of the access commands may be processed concurrently.

If the buffer 125 has sufficient space to store the write data, the memory system controller 115 may cause the interface 120 to transmit an indication of availability to the host system 105 (e.g., a “ready to transfer” indication), which may be performed in accordance with a protocol (e.g., a UFS protocol, an eMMC protocol). As the interface 120 receives the data associated with the write command from the host system 105, the interface 120 may transfer the data to the buffer 125 for temporary storage using the data path 150. In some cases, the interface 120 may obtain (e.g., from the buffer 125, from the buffer queue 165) the location within the buffer 125 to store the data. The interface 120 may indicate to the memory system controller 115 (e.g., via the bus 135) if the data transfer to the buffer 125 has been completed.

After the write data has been stored in the buffer 125 by the interface 120, the data may be transferred out of the buffer 125 and stored in a memory device 140, which may involve operations of the storage controller 130. For example, the memory system controller 115 may cause the storage controller 130 to retrieve the data from the buffer 125 using the data path 150 and transfer the data to a memory device 140. The storage controller 130 may be considered a back end of the memory system 110. The storage controller 130 may indicate to the memory system controller 115 (e.g., via the bus 135) that the data transfer to one or more memory devices 140 has been completed.

In some cases, a storage queue 170 may support a transfer of write data. For example, the memory system controller 115 may push (e.g., via the bus 135) write commands from the buffer queue 165 to the storage queue 170 for processing. The storage queue 170 may include entries for each access command. In some examples, the storage queue 170 may additionally include a buffer pointer (e.g., an address) that may indicate where in the buffer 125 the data associated with the command is stored and a storage pointer (e.g., an address) that may indicate the location in the memory devices 140 associated with the data. In some cases, the storage controller 130 may obtain (e.g., from the buffer 125, from the buffer queue 165, from the storage queue 170) the location within the buffer 125 from which to obtain the data. The storage controller 130 may manage the locations within the memory devices 140 to store the data (e.g., performing wear-leveling, performing garbage collection). The entries may be added to the storage queue 170 (e.g., by the memory system controller 115). The entries may be removed from the storage queue 170 (e.g., by the storage controller 130, by the memory system controller 115) after completion of the transfer of the data.

To process a read command received from the host system 105, the memory system controller 115 may determine if the buffer 125 has sufficient available space to store the data associated with the command. For example, the memory system controller 115 may determine (e.g., via firmware, via controller firmware), an amount of space within the buffer 125 that may be available to store data associated with the read command.

In some cases, the buffer queue 165 may support buffer storage of data associated with read commands in a similar manner as discussed with respect to write commands. For example, if the buffer 125 has sufficient space to store the read data, the memory system controller 115 may cause the storage controller 130 to retrieve the data associated with the read command from a memory device 140 and store the data in the buffer 125 for temporary storage using the data path 150. The storage controller 130 may indicate to the memory system controller 115 (e.g., via the bus 135) when the data transfer to the buffer 125 has been completed.

In some cases, the storage queue 170 may be used to aid with the transfer of read data. For example, the memory system controller 115 may push the read command to the storage queue 170 for processing. In some cases, the storage controller 130 may obtain (e.g., from the buffer 125, from the storage queue 170) the location within one or more memory devices 140 from which to retrieve the data. In some cases, the storage controller 130 may obtain (e.g., from the buffer queue 165) the location within the buffer 125 to store the data. In some cases, the storage controller 130 may obtain (e.g., from the storage queue 170) the location within the buffer 125 to store the data. In some cases, the memory system controller 115 may move the command processed by the storage queue 170 back to the command queue 160.

After the data has been stored in the buffer 125 by the storage controller 130, the data may be transferred from the buffer 125 and sent to the host system 105. For example, the memory system controller 115 may cause the interface 120 to retrieve the data from the buffer 125 using the data path 150 and transmit the data to the host system 105 (e.g., according to a protocol, such as a UFS protocol or an eMMC protocol). For example, the interface 120 may process the command from the command queue 160 and may indicate to the memory system controller 115 (e.g., via the bus 135) that the data transmission to the host system 105 has been completed.

The memory system controller 115 may execute received commands according to an order (e.g., a first-in-first-out order, according to the order of the command queue 160). For each command, the memory system controller 115 may cause data corresponding to the command to be moved into and out of the buffer 125, as discussed herein. As the data is moved into and stored within the buffer 125, the command may remain in the buffer queue 165. A command may be removed from the buffer queue 165 (e.g., by the memory system controller 115) if the processing of the command has been completed (e.g., if data corresponding to the access command has been transferred out of the buffer 125). If a command is removed from the buffer queue 165, the address previously storing the data associated with that command may be available to store data associated with a new command.

In some examples, the memory system controller 115 may be configured for operations associated with one or more memory devices 140. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 105 and physical addresses (e.g., physical block addresses) associated with memory cells within the memory devices 140. For example, the host system 105 may issue commands indicating one or more LBAs and the memory system controller 115 may identify one or more physical block addresses indicated by the LBAs. In some cases, one or more contiguous LBAs may correspond to noncontiguous physical block addresses. In some cases, the storage controller 130 may be configured to perform one or more of the described operations in conjunction with or instead of the memory system controller 115. In some cases, the memory system controller 115 may perform the functions of the storage controller 130 and the storage controller 130 may be omitted. The memory system controller 115, interface 120, buffer 125, storage controller 130, and bus 135 may be components of a controller integrated circuit, such as an ASIC.

In some cases, the memory system 100 may be associated with a relatively large sleep exit latency. For example, when the host system 105 issues a command that triggers the memory system 110 to exit a sleep state, the memory system 110 may first perform a wakeup procedure for hardware components of memory system controller 115. The wakeup procedure may include an initialization for one or more memory interfaces 175, such as an open NAND flash interface (ONFI). The initialization of the memory interface 175 may include initialization of a memory bus 178 (e.g., ONFI bus), which may include training and parameter setting for the memory bus 178. A memory interface 175 such as the ONFI may then trigger an initialization (e.g., via the memory bus 178) for one or more memory devices 140 of the memory system 110. As such, in this example the initialization for the memory devices 140 does not begin until after the wakeup procedure for the memory interface 175 has taken place, causing longer delays for read response and query response by the memory system 110. Additionally, or alternatively, there may be a mismatch of ONFI configurations between the memory system 110 and other systems (e.g., universal flash storage (UFS) systems) interfacing with the ONFI (e.g., due to a restart resetting the ONFI configuration back to default for another system), which may further cause issues between the memory system 110 and the other systems. Accordingly, techniques for triggering the initialization procedure without relying on the ONFI may be desired.

In accordance with examples as described herein, the memory system 110 may perform an initialization procedure for the memory devices 140 in parallel with hardware wakeup procedures (e.g., for controller IC 112). To perform the initialization procedure in parallel with the hardware wakeup procedures, the initialization procedure may be triggered by issuing a signal via a signal pin 180 (e.g., an I/O pin) of controller IC 112 of the memory system 110 to the memory devices 140. Signal pin 180 maybe separate from the memory bus 178. In some examples, the controller IC 112 may include an additional signal pin 180 dedicated to triggering the initialization procedure for the memory devices 140. Additionally, or alternatively, the memory system may repurpose one or more existing signal pins 180 of controller IC 112 to trigger the initialization procedure. In some cases, the existing signal pins may return to their original function following the initialization procedure. Further, the memory system 110 may overwrite one or more trim parameters of the memory devices 140 to cause the signal pins to be used for the initialization procedure or a reset procedure.

The system 100 may include any quantity of non-transitory computer readable media that support triggering of NAND initialization. For example, the host system 105, the memory system 110, the controller IC 112, the memory system controller 115, or a memory device 140 may include or otherwise may access one or more non-transitory computer readable media storing instructions (e.g., firmware, logic, code) for performing the functions ascribed herein to the host system 105, the memory system 110, or a memory device 140. For example, such instructions, if executed by the host system 105, by the memory system 110 (e.g., by memory system controller 115), or by a memory device 140, may cause the host system 105, the memory system 110, or the memory device 140 to perform associated functions as described herein.

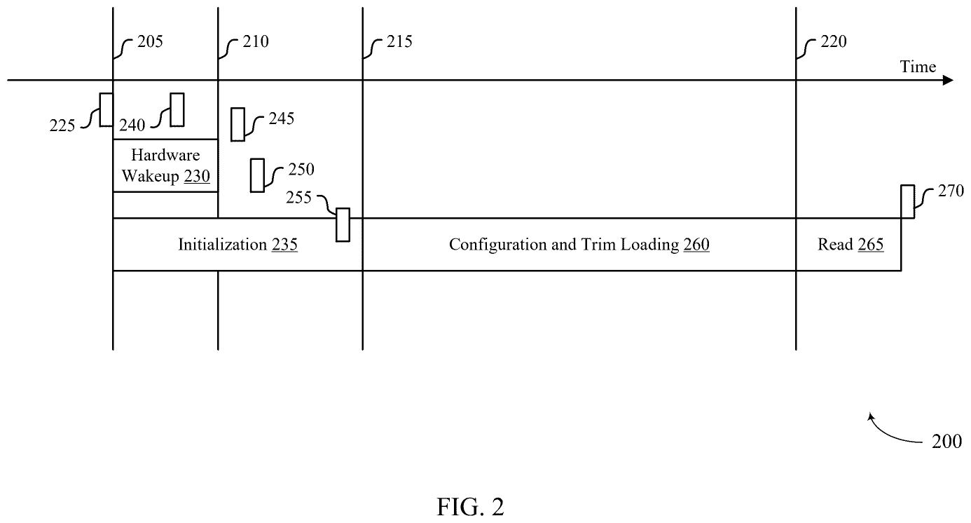

FIG. 2 shows an example of a timing diagram 200 that supports triggers for initialization procedures in accordance with examples as disclosed herein. The timing diagram 200 illustrates how a memory system (e.g., the memory system 110, described with reference to FIG. 1) may initiate an initialization procedure 235 for one or more memory devices in parallel with hardware wakeup procedures, as described herein.

The memory system may receive a command 225 from a host system. The command 225 may trigger the memory system to exit a sleep command (e.g., explicitly, using a wakeup command, or implicitly, by issuing an access command or query). At 205, the memory system may initiate a hardware wakeup procedure 230 (e.g., an ASIC wakeup procedure), which may begin initialization of one or more hardware components including a controller or an interface of the memory system. The memory system may also issue, prior to completing the hardware wakeup procedure 230, a signal via signal pin of the controller (e.g., the ASIC) to trigger the initialization procedure 235 for the one or more memory devices.

In some examples, between 205 and 210, the host device may output a signal 240 that the host device is active, for example, a user datagram protocol (UDP) such as secure semi-reliable UDP (SSU). At 210, the hardware wakeup procedure 230 may be finalized. Then, the memory system may issue a response 245 to the signal 240. After receiving the response 245, the host device may issue a message 250 indicating a query or a read command. The memory system may issue a query response 255 in response to the message 250.

At 215, the initialization procedure 235 may be finalized. The memory system may begin a loading operation 260 to load configurations and trim parameters for the one or more memory systems. At 220, the memory system may perform a read operation 265 based on the message 250. In some examples, the read operation 265 may involve performing a scan of the one or more memory systems, and then performing one or more access commands. The memory system may then issue a read response 270 in response to the message 250. Accordingly, by performing the initialization procedure 235 in parallel with the hardware wakeup procedure 230, the memory system may reduce a latency associated with the wakeup procedure, the query response 255, and the read response 270.

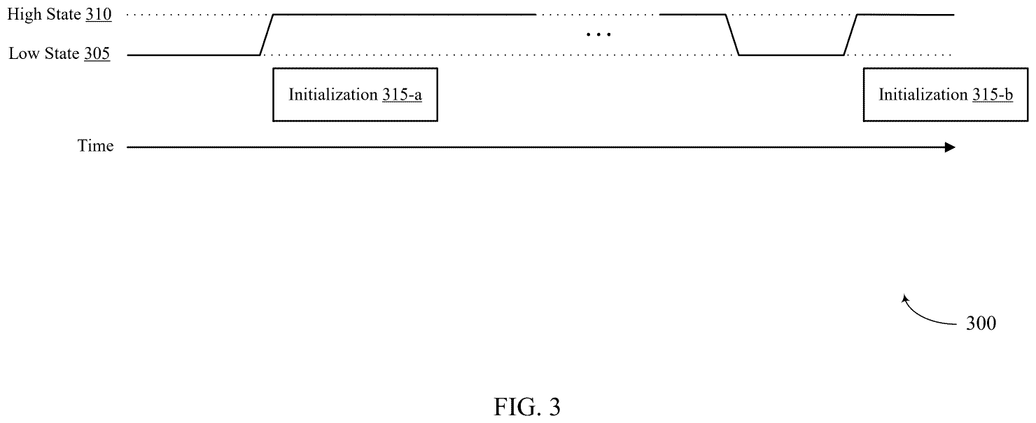

FIG. 3 shows an example of a diagram 300 that supports triggers for initialization procedures in accordance with examples as disclosed herein. The diagram 300 illustrates a state (e.g., an electrical state) of a signal pin (e.g., a pad) of a controller (e.g., an ASIC) of a memory system, such as the memory system 110 as described herein.

The signal pin may be a pin of the controller of the memory system and may be coupled with one or more pins of one or more memory devices to output signaling from the memory system to the one or more memory devices. For example, the signal pin may transition between a low state 305 (e.g., a low voltage, a zero voltage) and a high state 310 (e.g., a high voltage). In some examples, the signal pin may be a dedicated signal pin for triggering an initialization procedure for the one or more memory devices. Additionally, or alternatively, the signal pin may have multiple functions. For example, the signal pin of the one or more memory devices may be a write protect (WP) signal pin, a multi-die select (MDS) signal pin (e.g., an MDS3 signal pin), or another signal pin. In some cases, the signal pin may be a GPIO pin of the controller that may drive the one or more signal pins of the one or more memory devices.

The signal pin may begin in the low state 305. For example, the memory system may perform a power up procedure, in which voltages of the memory system (e.g., Vcc or Vccq voltages) power up to a respective threshold voltage. After the power up procedure, the memory system (e.g., the controller of the memory system) may drive the signal pin from the low state 305 to the high state 310 (e.g., prior to completion of a wakeup procedure for the controller or a memory interface of a controller IC). The one or more memory devices may receive a signal via one or more respective pins that triggers an initialization 315-a (e.g., an initialization procedure) based on the signal pin transitioning from the low state 305 to the high state 310. For example, the transition from the low state 305 to the high state 310 may signal the one or more memory devices to begin the initialization 315-a. While the diagram 300 illustrates the transition from the low state 305 to the high state 310 triggering the initialization 315-a, in other examples, the transition from the high state 310 to the low state 305 (e.g., or from any first state to a different second state) may trigger the initialization 315-a.

In some cases, after the initialization 315-a, transitions of the signal pin between the high state 310 and the low state 305 may trigger different operations for the one or more memory devices. In some examples, the signal pin may be used for resetting the one or more memory devices. For instance, the memory system may drive the signal pin from the high state 310 to the low state 305, and from the low state 305 to the high state 310 to trigger an initialization 315-b. In some examples, the initialization 315-b may be a same procedure as the initialization 315-a, and the initialization 315-b may fully reset the one or more memory devices. In some other examples, the initialization 315-b may trigger a reset for one or more components of the one or more memory devices, such as a reset for the ONFI, or may trigger a reload for an ASIC ROM. As such, the one or more memory devices may perform the initialization 315-b in response (e.g., in direct response) to receiving the signal via the signal pin.

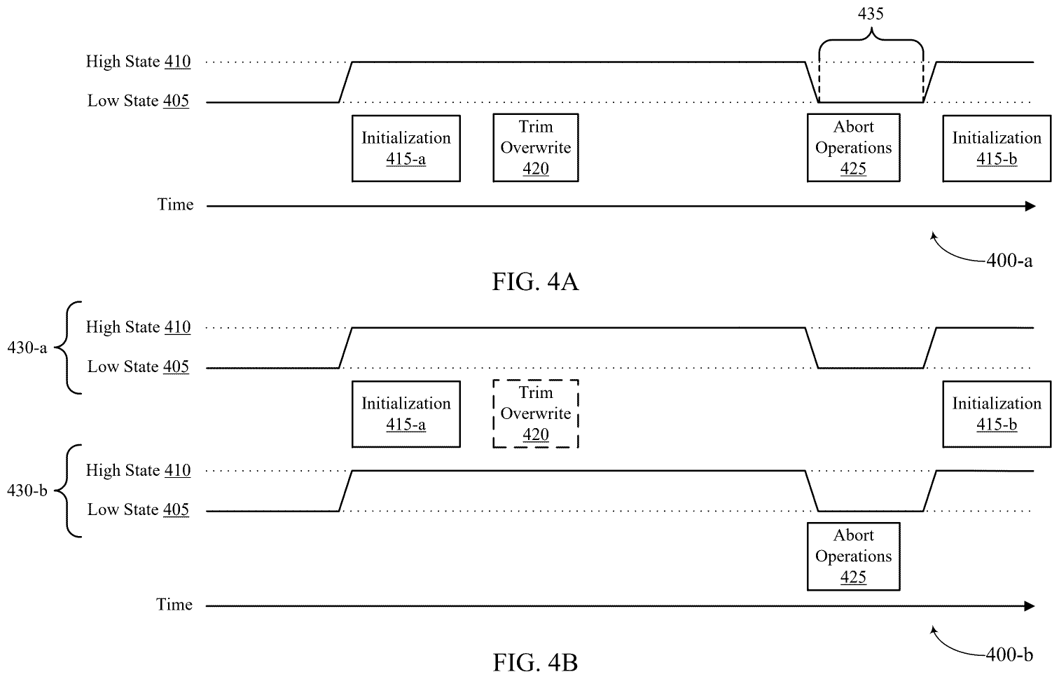

Additionally, or alternatively, the signal pin may switch functions based on performing the initialization 315-a. For example, if the signal pin of the controller is a WP pin, the signal pin may return to functionality associated with WP after performing the initialization 315-a. For instance, the signal pin may be used by the memory system to trigger the one or more memory devices to abort (e.g., stop) a program operation or an erase operation, for example, when the signal pin transitions from the high state 310 to the low state 305. Similarly, if the signal pin is an MDS pin, the signal pin may return to functionality associated with the MDS pin after performing the initialization 315-a. For example, the signal pin may be configured to provide, to the one or more memory devices, at least a portion of an address associated with the one or more memory devices. In some cases, for instance, the MDS pin (e.g., the MDS3 pin) may provide a fourth bit (e.g., a most significant bit) associated with the address, which may be the same for each the one or more memory devices. In some examples, the function of the signal pin may be switched to cause the signal pin to return to being used for initialization procedures, which is described in more detail with reference to FIGS. 4A and 4B.

In some cases, if the signal pin is not to be used for the initialization 315-a, the controller may refrain from transitioning the signal pin from the low state 305 to the high state 310. This may cause the initialization 315-a to be triggered by an interface (e.g., the ONFI) of the controller at a later time, for example, after the hardware wakeup procedure is completed. In these cases, the signal pin may be used for the original functionality (e.g., WP or MDS). In some examples, the controller may update one or more trim parameters of the one or more memory devices to cause the signal pin to trigger the initialization 315-b (e.g., a reset) of the one or more memory devices.

Accordingly, by issuing a signal via the signal pin to trigger the initialization 315-a for the one or more memory devices, the memory system may begin initialization procedures at an earlier time, such as in parallel with other hardware wakeup procedures, thereby reducing a latency associated with exiting a sleep state. As such, the memory system may perform one or more access operations at the one or more memory devices with reduced latency.

FIG. 4A and FIG. 4B show examples of a diagram 400-a and a diagram 400-b that support triggers for initialization procedures in accordance with examples as disclosed herein. The diagram 400-a and the diagram 400-b illustrates a state (e.g., an electrical state) of pins (e.g., a pads) of one or more memory devices as driven by a controller (e.g., a controller IC) of a memory system, such as the memory system 110 as described herein, via a signal pin (e.g., a GPIO signal pin).

The diagram 400-a illustrates how the memory system may use the signal pin to trigger different operations at the one or more memory devices. The memory system may receive a command from a host device indicating the memory system to exit a sleep state. In response to the command, the memory system may initiate a wakeup procedure for a controller of the memory system (e.g., a controller IC), which may involve a configuration of an interface (e.g., an ONFI) between the controller and the one or more memory devices. Prior to completion of the configuration of the interface (e.g., at least partially in parallel), the memory system may issue a signal via the signal pin of the controller, such as by transitioning the signal pin from a low state 405 to a high state 410. This may transition one or more pins of the one or more memory devices coupled with the signal pin from the low state 405 to the high state 410, which may trigger an initialization 415-a (e.g., an initialization procedure) of the one or more memory devices.

In some examples, after triggering the initialization 415-a, the signal pin may be used for different functions. For example, the signal pin may be a WP pin, and after the initialization 415-a, the signal pin may be used by the memory system to abort program operations, read operations, or erase operations, or a combination thereof at the one or more memory devices. In some other examples, the signal pin may be an MDS pin (e.g., an MDS3 pin), and the signal pin may indicate at least a portion of an address associated with the one or more memory devices to the one or more memory devices after triggering the initialization 415-a.

The controller of the memory system may perform a trim overwrite 420 to update a function of the signal pin on the one or more memory devices. For example, after completion of the initialization 415-a, the controller may update one or more trim parameters (e.g., a mobile trim) of the one or more memory devices. The trim overwrite 420 may change the behavior of the one or more memory devices in response to signals issued via the signal pin. For example, after the trim overwrite 420, the one or more memory devices may abort operations 425, such as program operations, erase operations, read operations, or a combination thereof, after the signal pin transitions from the high state 410 to the low state 405 (e.g., on the falling edge). Additionally, or alternatively, the signal pin may perform an initialization 415-b (e.g., a reset) based on transitioning from the low state 405 to the high state 410 (e.g., on the rising edge).

In some examples, it may be beneficial for the memory devices to abort operations 425 prior to the initialization 415-b such that all array commands are dropped prior to performing the initialization 415-b. As such, triggering the abort operations 425 based on transitioning the signal pin to the low state 405 may cause the abort operations 425 to precede the initialization 415-b. In some cases, the memory system may wait a reset timing 435 (e.g., 100 ns) from transitioning to the low state 405 before transitioning to the high state 410 to trigger the initialization 415-b. As such, the memory system may provide sufficient time for the one or more memory devices to abort operations 425 prior to performing the initialization 415-b, for example.

Additionally, or alternatively, associating the initialization 415-b with the abort operations 425 may support resetting the one or more memory devices in case of a power (e.g., a voltage, such as Vcc) brownout. For instance, if a power brownout occurs, the voltage of the signal pin may drop, transitioning to the low state 405. This may trigger the one or more memory devices to abort operations 425, and the one or more memory devices may stop all program or erase procedures. When the power (e.g., Vcc) returns to a threshold level, the signal pin may be driven back to the high state 410, which may trigger the one or more memory devices to reset based on the initialization 415-b.

In some examples, as illustrated by the diagram 400-b, the signal pin of the controller of the memory device may be configured to drive multiple pins of the one or more memory devices. For example, the signal pin (e.g., the GPIO pin) may be coupled with a pin 430-a (e.g., a dedicated reset pin) of the one or more memory devices and a pin 430-b (e.g., a WP pin or an MDS pin) of the one or more memory devices. As such, the memory system may support signaling via multiple pins of the one or more memory devices using a single signal pin, without the memory system having to support additional signal pins for the initialization 415-a.

For example, the memory system may drive the signal pin from the low state 405 to the high state 410, which may drive both the pin 430-a and the pin 430-b from the low state 405 to the high state 410. The one or more memory devices may perform an initialization 415-a based detecting that the pin 430-a transitioned to the high state 410. For example, the one or more memory devices may perform the initialization 415-a based on a signal received via the pin 430-a. The controller of the memory system may drive the signal pin from the high state 410 to the low state, which may drive both the pin 430-a and the pin 430-b from the high state 410 to the low state 405. The one or more memory systems may detect that the pin 430-b transitioned to the low state 405, and may abort operations 425 in response (e.g., abort program operations, read operations, erase operations, or a combination thereof). The controller may drive the signal pin to the high state 410 again, which may trigger the initialization 415-b at the one or more memory devices via the pin 430-a.

In some examples, the controller may perform the trim overwrite 420 to update one or more trim parameters and change functions of the pin 430-a, the pin 430-b, or both. For example, the pin 430-a may be an MDS pin, and may return to MDS functions (e.g., indicating a portion of an address of the one or more memory devices) after the initialization 415-a. After the trim overwrite 420, the pin 430-a may instead trigger the initialization 415-b at the one or more memory devices when transitioning to the high state 410. Additionally, or alternatively, the functions of the pin 430-b, which may be a WP pin, may be altered based on the trim overwrite 420. For example, prior to the trim overwrite 420, the pin 430-b may cause aborting of program operations and erase operations at the one or more memory devices based on transitioning from the high state 410 to the low state 405. After the trim overwrite 420, the pin 430-b may additionally cause aborting of read operations based on transitioning from the high state 410 to the low state 405.

Accordingly, the controller may use one signal pin (e.g., a GPIO pin) to drive one or more pins (e.g., NAND pads) for the one or more memory devices, thereby supporting triggering of the initialization 415-a in parallel with other hardware wakeup procedures (e.g., ASIC wakeup, GPIO wakeup) while preserving the functionality of existing pins at the one or more memory devices.

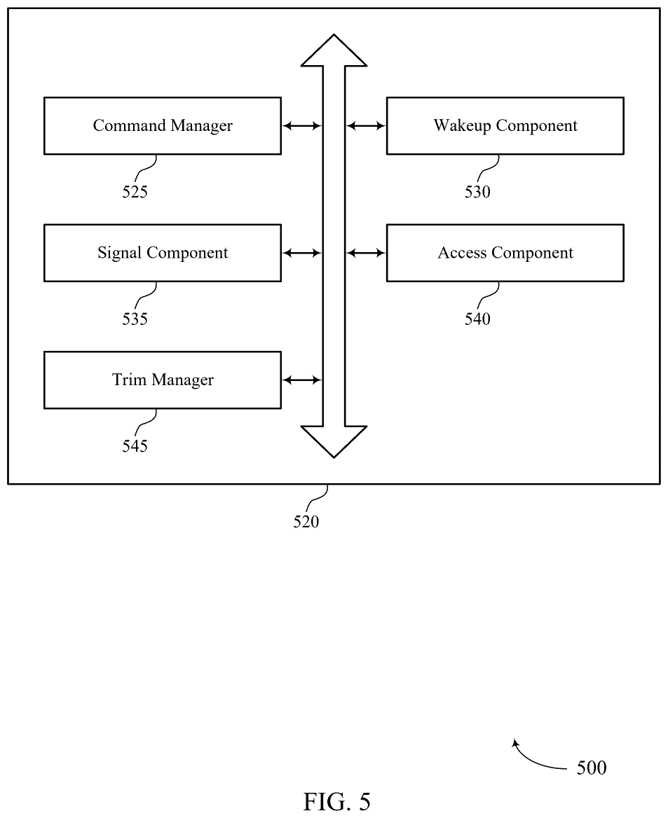

FIG. 5 shows a block diagram 500 of a memory system 520 that supports triggers for initialization procedures in accordance with examples as disclosed herein. The memory system 520 may be an example of aspects of a memory system as described with reference to FIGS. 1 through 4. The memory system 520, or various components thereof, may be an example of means for performing various aspects of NAND initialization trigger as described herein. For example, the memory system 520 may include a command manager 525, a wakeup component 530, a signal component 535, an access component 540, a trim manager 545, or any combination thereof. Each of these components, or components of subcomponents thereof (e.g., one or more processors, one or more memories), may communicate, directly or indirectly, with one another (e.g., via one or more buses).

The command manager 525 may be configured as or otherwise support a means for receiving, from a host device, a first command that indicates the memory system to exit a sleep state, where the memory system includes one or more memory devices. The wakeup component 530 may be configured as or otherwise support a means for initiating, in response to the first command, a wakeup procedure for a controller of the memory system, the wakeup procedure including a configuration of an interface between the controller and the one or more memory devices. The signal component 535 may be configured as or otherwise support a means for issuing, prior to completion of the configuration of the interface and in response to the first command, a first signal via a signal pin of the controller to the one or more memory devices to trigger an initialization procedure at the one or more memory devices. The access component 540 may be configured as or otherwise support a means for performing one or more access operations at the one or more memory devices in response to triggering the initialization procedure at the one or more memory devices.

In some examples, the signal component 535 may be configured as or otherwise support a means for issuing, after completion of the initialization procedure, a second signal via the signal pin of the controller to the one or more memory devices to trigger a second initialization procedure for the one or more memory devices.

In some examples, the trim manager 545 may be configured as or otherwise support a means for updating one or more trim parameters of the one or more memory devices after completion of the initialization procedure and prior to issuing the second signal, where the second initialization procedure is triggered by the second signal in response to updating the one or more trim parameters.

In some examples, the signal component 535 may be configured as or otherwise support a means for issuing a third signal via the signal pin of the memory system to abort an access operation. In some examples, the third signal is configured to abort the access operation in response to a transition of the signal pin from a second state to a first state. In some examples, the signal pin includes a write protect pin or a multi-die select pin.

In some examples, the signal pin is configured to trigger the initialization procedure at the one or more memory devices in response to a transition of the signal pin from a first state to a second state.

In some examples, the signal pin is coupled with a first pin of the one or more memory devices and a second pin of the one or more memory devices. In some examples, the first signal is issued via the signal pin to the first pin of the one or more memory devices and the second pin of the one or more memory devices.

In some examples, the first pin is associated with triggering initialization procedures for the one or more memory devices when the signal pin transitions from the first state to the second state, and the second pin is configured to abort an access operation for the one or more memory devices when the signal pin transitions from the second state to the first state. In some examples, the second pin is configured to provide at least a portion of an address associated with the one or more memory devices to the one or more memory devices.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

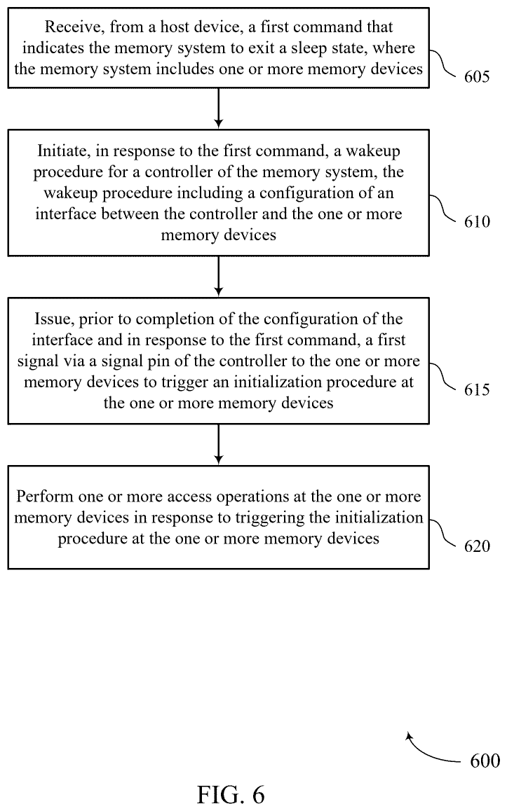

FIG. 6 shows a flowchart illustrating a method 600 that supports triggers for initialization procedures in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include receiving, from a host device, a first command that indicates the memory system to exit a sleep state, where the memory system includes one or more memory devices. In some examples, aspects of the operations of 605 may be performed by a command manager 525 as described with reference to FIG. 5.

At 610, the method may include initiating, in response to the first command, a wakeup procedure for a controller of the memory system, the wakeup procedure including a configuration of an interface between the controller and the one or more memory devices. In some examples, aspects of the operations of 610 may be performed by a wakeup component 530 as described with reference to FIG. 5.

At 615, the method may include issuing, prior to completion of the configuration of the interface and in response to the first command, a first signal via a signal pin of the controller to the one or more memory devices to trigger an initialization procedure at the one or more memory devices. In some examples, aspects of the operations of 615 may be performed by a signal component 535 as described with reference to FIG. 5.

At 620, the method may include performing one or more access operations at the one or more memory devices in response to triggering the initialization procedure at the one or more memory devices. In some examples, aspects of the operations of 620 may be performed by an access component 540 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, from a host device, a first command that indicates the memory system to exit a sleep state, where the memory system includes one or more memory devices; initiating, in response to the first command, a wakeup procedure for a controller of the memory system, the wakeup procedure including a configuration of an interface between the controller and the one or more memory devices; issuing, prior to completion of the configuration of the interface and in response to the first command, a first signal via a signal pin of the controller to the one or more memory devices to trigger an initialization procedure at the one or more memory devices; and performing one or more access operations at the one or more memory devices in response to triggering the initialization procedure at the one or more memory devices.

Aspect 2: The method, apparatus, or non-transitory computer-readable medium of aspect 1, further including operations, features, circuitry, logic, means, or instructions, or any combination thereof for issuing, after completion of the initialization procedure, a second signal via the signal pin of the controller to the one or more memory devices to trigger a second initialization procedure for the one or more memory devices.

Aspect 3: The method, apparatus, or non-transitory computer-readable medium of aspect 2, further including operations, features, circuitry, logic, means, or instructions, or any combination thereof for updating one or more trim parameters of the one or more memory devices after completion of the initialization procedure and prior to issuing the second signal, where the second initialization procedure is triggered by the second signal in response to updating the one or more trim parameters.

Aspect 4: The method, apparatus, or non-transitory computer-readable medium of any of aspects 1 through 3, further including operations, features, circuitry, logic, means, or instructions, or any combination thereof for issuing a third signal via the signal pin of the memory system to abort an access operation.

Aspect 5: The method, apparatus, or non-transitory computer-readable medium of aspect 4, where the third signal is configured to abort the access operation in response to a transition of the signal pin from a second state to a first state.

Aspect 6: The method, apparatus, or non-transitory computer-readable medium of any of aspects 1 through 5, where the signal pin includes a write protect pin or a multi-die select pin.

Aspect 7: The method, apparatus, or non-transitory computer-readable medium of any of aspects 1 through 6, where the signal pin is configured to trigger the initialization procedure at the one or more memory devices in response to a transition of the signal pin from a first state to a second state.

Aspect 8: The method, apparatus, or non-transitory computer-readable medium of aspect 7, where the signal pin is coupled with a first pin of the one or more memory devices and a second pin of the one or more memory devices and the first signal is issued via the signal pin to the first pin of the one or more memory devices and the second pin of the one or more memory devices.

Aspect 9: The method, apparatus, or non-transitory computer-readable medium of aspect 8, where the first pin is associated with triggering initialization procedures for the one or more memory devices when the signal pin transitions from the first state to the second state, and the second pin is configured to abort an access operation for the one or more memory devices when the signal pin transitions from the second state to the first state.

Aspect 10: The method, apparatus, or non-transitory computer-readable medium of any of aspects 8 through 9, where the second pin is configured to provide at least a portion of an address associated with the one or more memory devices to the one or more memory devices.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 11: A memory device, including: one or more memory arrays; a signal pin; and processing circuitry coupled with the signal pin and the one or more memory arrays and configured to cause the memory device to: receive a first signal via the signal pin to trigger an initialization procedure for the memory device in response to a transition of the signal pin from a first state to a second state; perform one or more access operations at the one or more memory arrays in response to the initialization procedure; and receive, after completion of the initialization procedure, a second signal via the signal pin to abort an access operation, in response to a transition of the signal pin from the second state to the first state.

Aspect 12: The memory device of aspect 11, where the processing circuitry is further configured to cause the memory device to: receive a third signal via the signal pin to trigger a second initialization procedure for the memory device in response to a transition of the signal pin from the first state to the second state.

Aspect 13: The memory device of aspect 12, where the processing circuitry is further configured to cause the memory device to: update one or more trim parameters of the memory device, where the second initialization procedure is triggered by the signal pin in response to the update of the one or more trim parameters.

Aspect 14: The memory device of aspect 13, where the signal pin indicates at least a portion of an address associated with the memory device in relation to one or more additional memory devices for a duration after the initialization procedure and prior to the update of the one or more trim parameters.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive, from a host device, a first command that indicates the memory system to exit a sleep state, wherein the memory system comprises one or more memory devices;
initiate, in response to the first command, a wakeup procedure for a controller of the memory system, the wakeup procedure comprising a configuration of an interface between the controller and the one or more memory devices;
issue, prior to completion of the configuration of the interface and in response to the first command, a first signal via a signal pin of the controller to the one or more memory devices to trigger an initialization procedure at the one or more memory devices; and
perform one or more access operations at the one or more memory devices in response to triggering the initialization procedure at the one or more memory devices.

2. The memory system of claim 1, wherein the processing circuitry is further configured to cause the memory system to:
issue, after completion of the initialization procedure, a second signal via the signal pin of the controller to the one or more memory devices to trigger a second initialization procedure for the one or more memory devices.

3. The memory system of claim 2, wherein the processing circuitry is further configured to cause the memory system to:
update one or more trim parameters of the one or more memory devices after completion of the initialization procedure and prior to issuing the second signal, wherein the second initialization procedure is triggered by the second signal in response to updating the one or more trim parameters.

4. The memory system of claim 1, wherein the processing circuitry is further configured to cause the memory system to:
issue a third signal via the signal pin of the memory system to abort an access operation.

5. The memory system of claim 4, wherein the third signal is configured to abort the access operation in response to a transition of the signal pin from a second state to a first state.

6. The memory system of claim 1, wherein the signal pin comprises a write protect pin or a multi-die select pin.

7. The memory system of claim 1, wherein the signal pin is configured to trigger the initialization procedure at the one or more memory devices in response to a transition of the signal pin from a first state to a second state.

8. The memory system of claim 7, wherein the signal pin is coupled with a first pin of the one or more memory devices and a second pin of the one or more memory devices, and wherein the first signal is issued via the signal pin to the first pin of the one or more memory devices and the second pin of the one or more memory devices.

9. The memory system of claim 8, wherein the first pin is associated with triggering initialization procedures for the one or more memory devices when the signal pin transitions from the first state to the second state, and the second pin is configured to abort an access operation for the one or more memory devices when the signal pin transitions from the second state to the first state.

10. The memory system of claim 8, wherein the second pin is configured to provide at least a portion of an address associated with the one or more memory devices to the one or more memory devices.

11. A memory device, comprising:
one or more memory arrays;
a signal pin; and
processing circuitry coupled with the signal pin and the one or more memory arrays and configured to cause the memory device to:
receive a first signal via the signal pin to trigger an initialization procedure for the memory device in response to a transition of the signal pin from a first state to a second state;
perform one or more access operations at the one or more memory arrays in response to the initialization procedure; and
receive, after completion of the initialization procedure, a second signal via the signal pin to abort an access operation, in response to a transition of the signal pin from the second state to the first state.

12. The memory device of claim 11, wherein the processing circuitry is further configured to cause the memory device to:
receive a third signal via the signal pin to trigger a second initialization procedure for the memory device based in response to a transition of the signal pin from the first state to the second state.

13. The memory device of claim 12, wherein the processing circuitry is further configured to cause the memory device to:
update one or more trim parameters of the memory device, wherein the second initialization procedure is triggered by the signal pin in response to the update of the one or more trim parameters.

14. The memory device of claim 13, wherein the signal pin indicates at least a portion of an address associated with the memory device in relation to one or more additional memory devices for a duration after the initialization procedure and prior to the update of the one or more trim parameters.

15. A method by a memory system, comprising:
receiving, from a host device, a first command that indicates the memory system to exit a sleep state, wherein the memory system comprises one or more memory devices;
initiating, in response to the first command, a wakeup procedure for a controller of the memory system, the wakeup procedure comprising a configuration of an interface between the controller and the one or more memory devices;
issuing, prior to completion of the configuration of the interface and in response to the first command, a first signal via a signal pin of the controller to the one or more memory devices to trigger an initialization procedure at the one or more memory devices; and
performing one or more access operations at the one or more memory devices in response to triggering the initialization procedure at the one or more memory devices.

16. The method of claim 15, further comprising:
issuing, after completion of the initialization procedure, a second signal via the signal pin of the controller to the one or more memory devices to trigger a second initialization procedure for the one or more memory devices.

17. The method of claim 16, further comprising:
updating one or more trim parameters of the one or more memory devices after completion of the initialization procedure and prior to issuing the second signal, wherein the second initialization procedure is triggered by the second signal in response to updating the one or more trim parameters.

18. The method of claim 15, further comprising:
issuing a third signal via the signal pin of the memory system to abort an access operation.

19. The method of claim 18, wherein the third signal is configured to abort the access operation in response to a transition of the signal pin from a second state to a first state.

20. The method of claim 15, wherein the signal pin comprises a write protect pin or a multi-die select pin.
